(19) United States
(12) Patent Application Publication
(10) Pub. No.: US 2008/0167965 A1
(43) Pub. Date: Jul. 10, 2008

(54) APPARATUS, SYSTEM, AND METHOD FOR EXTRACTING REAL WORLD VALUE FROM A VIRTUAL ACCOUNT

(76) Inventors: Bernard VON NOTHAUS, Evansville, IN (US); Jason W. PRATT, Austin, TX (US)

Correspondence Address: Kunzler & McKenzie, 8 EAST BROADWAY, SUITE 600, SALT LAKE CITY, UT, 84111, US

(21) Appl. No.: 11/971,662

(22) Filed: Jan. 9, 2008

Related U.S. Application Data
(60) Provisional application No. 60/884,172, filed on Jan. 9, 2007.

(51) Int. Cl. G06Q 20/00

(52) U.S. Cl. 705/17; 705/16

(57) ABSTRACT

An apparatus, system, and method are disclosed for extracting real world value from a virtual account by receiving point-of-sale information from a consumer, converting a real currency purchase amount to an equivalent virtual value, and processing the transaction. The point-of-sale information comprises a real currency purchase amount and account information, the account information determined from a bank card. Converting the real currency purchase amount utilizes a current real-to-virtual exchange rate associated with a virtual medium. The transaction is processed by debiting a current virtual value balance by the equivalent virtual value, the current virtual value balance associated with an account naming at least the consumer, the account determinable from the account information. Beneficially, the invention provides easy, real-world access to virtual value in a virtual medium.

### CROSS-REFERENCES TO RELATED APPLICATIONS

This application claims priority to U.S. Provisional Patent Application No. 60/884,172 entitled “APPARATUS, SYSTEM, AND METHOD FOR EXTRACTING REAL WORLD VALUE FROM A VIRTUAL ACCOUNT” and filed on Jan. 9, 2007 for Bernard von NotHaus, et al., which is incorporated herein by reference.

### BACKGROUND OF THE INVENTION

1. Field of the Invention

This invention relates to credit/debit transactions and more particularly relates to credit/debit transactions backed by virtual assets.

2. Description of the Related Art

A common way to purchase goods and services in the modern economy is the credit card. A credit card allows a credit provider to effectively lend the user money to cover the cost of a purchase. When a purchase is made, the credit card issuer pays the purchase price to the seller, often withholding a fee for the service. In addition, the credit card user agrees to pay the card issuer the price of the purchase. At regular intervals, the card user is issued a bill from the credit card issuer for payment of money to cover the cost of purchases and any associated fees. Charge cards operate under similar principles, but require the charge card user to pay the entire balance at a regular interval.

Credit card users often face difficulties in paying the bills associated with their credit cards. Interest charges can be high, as can other fees associated with the use of the card. One justification for these high costs is the risk taken on by the credit card issuer associated with the loan in relation to inflation. The relative value of the loan may decrease under inflationary pressures; therefore, the lender must make a substantial return to hedge that risk.

A similar purchase system is the debit card, which requires the card user to maintain an account funded with money. A debit card allows a debit provider to pay the seller the price of the transaction and debit the price against the funds in the card user's account. Debit cards shift the risk associated with devaluation of the currency funding the account to the debit card user, who must maintain a balance of money in order to use the debit card. Inflation reduces the purchasing power of the money in the account, and a debit card user may find that the value of the money tied up in the debit card account is dramatically lower than it was when deposited.

In the U.S., credit, debit, and charge cards use the U.S. dollar to pay for purchases, calculate finance charges, and determine the amount owed. Card users in other countries typically use their local currency to track the amounts in debit or credit accounts. Regardless of the local currency used, inflation poses a risk to the users of the cards, either as increased costs and fees or as a direct risk to a deposit account backing a debit card.

Virtual worlds, or multi-dimensional computer-simulated environments, are gaining in popularity at a rapid pace. These virtual worlds, or “metaverses”, are intended for users to inhabit and interact via a defined representation of the user. An example of a virtual world is “Second Life” (secondlife.com), an immersive virtual experience resembling our real world using 3D computer graphics and animation. In this virtual world, land may be purchased and sold, buildings erected, services rendered and paid for, and any imaginable real world activity accommodated. Residents are individual people; however, large corporations like IBM have bought land, erected meeting and training facilities, and have been encouraging their employees to participate. Other consumer-based industries, like the automotive and fashion industries, have made advertising investments that have had large payouts in recognition and product sales. While some residents join a virtual world like Second Life for entertainment and/or to make supplemental income, others have made Second Life a full-time business and work exclusively in their virtual world.

Inhabitants of the real world have established generally-accepted real world values for elements in their physical environment for which exist units of measurement for communicating value. Like the real world, the participants in a virtual world may establish or adopt a virtual medium, a unit system of measurement wherein the unit has no formal value in an accredited real world banking institution. A virtual medium might be a virtual currency system in which the virtual digital currency is a representation of money that does not have a real world counterpart. The virtual world Second Life uses “Linden Dollars” as a virtual digital currency.

Another example of a virtual medium includes non-currency units such as points, reward points, bonus points, etc. that are accumulated and redeemed by a consumer in accordance with published rules directed to point accumulation and redemption. We have referred to non-currency units of a virtual medium as virtual credits. A virtual medium may then include a virtual digital currency or virtual credits. Accrual of a virtual digital currency or virtual credits by a user may be kept in a virtual account where balances are maintained in a virtual medium for a principal account owner.

Since there is a potential cross-over from a virtual world to the real world, such as presenting a virtual product for which a corresponding real product may exist, a virtual digital currency may take on a real world value. This is certainly true for individuals that are financially engaged in a virtual world or for companies that sell products or services in a virtual world. For example, currency transactions and business development has produced a healthy Second Life economy and over $600,000 US dollars is spent daily throughout Second Life, for an annual GDP of about $220 million.

While real world value may be accruing in a consumer's virtual digital currency account, such as the Linden Dollar, it is very awkward to attempt to use that virtual value in the real world. A typical process for gaining access to the real world value within a virtual digital currency account would involve requesting the redemption of virtual digital currency and then waiting for days for a real world check in an equivalent amount to be delivered. Furthermore, if the expenditure was actually less than anticipated, then some type of additional financial transaction would be necessary to place the remainder back into the virtual world, if that was the desire of the consumer.

Virtual credits, while having discernable value in the real world, are likewise awkward when it comes to extracting that real world value. Typically, virtual credits are highly restrictive as to the types of merchandise or services that may be obtained by a principal through virtual credit redemption. Therefore, a consumer may be forced to liquidate or trade a redeemed product or service in order to obtain a desired product or service.

### SUMMARY OF THE INVENTION

From the foregoing discussion, it should be apparent that a need exists for an apparatus, system, and method that for extracting real world value from a virtual account. Beneficially, such an apparatus, system, and method would provide a bank card backed by a virtual account, such as an account utilizing a virtual digital currency as the virtual medium or an account utilizing a virtual credit as the virtual medium.

The present invention has been developed in response to the present state of the art, and in particular, in response to the problems and needs in the art that have not yet been fully solved by currently available bank cards. Accordingly, the present invention has been developed to provide an apparatus, system, and method for extracting real world value from a virtual account that overcome many or all of the above-discussed shortcomings in the art.

A computer program product is provided with computer usable program code executable to perform operations for performing a financial transaction initiated at a point-of-sale station. These operations in the described embodiments include receiving point-of-sale information from a consumer comprising a real currency purchase amount and account information, the account information determined from a bank card. Additionally, the operations may include converting the real currency purchase amount to an equivalent virtual value utilizing a current real-to-virtual exchange rate associated with a virtual medium. In a further embodiment, the computer program product includes operations for processing the transaction, the processing comprising debiting a current virtual value balance by the equivalent virtual value, the current virtual value balance associated with an account naming at least the consumer, the account determinable from the account information.

The point-of-sale station, in one embodiment, is an automated teller machine (ATM). In an alternate embodiment, the point-of-sale station is a website. In yet another embodiment, the point-of-sale station comprises a retail card reader.

In certain embodiments, the bank card is a debit card. In another embodiment, the bank card is a credit card. In one embodiment, the computer program product includes operations for denying the transaction if the current virtual value balance is insufficient to proceed with the debit.

The virtual medium of the computer program product, in one embodiment, is a virtual digital currency. In another embodiment, the virtual medium is a virtual credit. In certain embodiments, the virtual credit comprises points that are earned in the account based upon the activities of the consumer.

The current virtual value balance, in certain embodiments, is incrementally based upon the consumer depositing real world currency into the account. In one embodiment, the current real-to-virtual exchange rate is published by a website, wherein the website offers services based on the virtual medium. In another embodiment, the current virtual value balance to be debited is a plurality of current virtual value balances. The account, in one embodiment, is a plurality of accounts.

A method of the present invention is also presented for performing a financial transaction initiated at a point-of-sale station. The method, in one embodiment, comprises receiving point-of-sale information comprising a real currency purchase amount and account information, the account information determined from a bank card. The method may further comprise determining that a virtual value balance in a first account associated with the account information is insufficient to complete the transaction.

In one embodiment, the method also comprises accessing a second account associated with the account information wherein the second account comprises a second balance or credit limit in a real world currency. The method may, in one embodiment, include processing the transaction, the processing comprising debiting at least a portion of the real currency purchase amount from the second balance. In certain embodiments, the method includes determining a first account associated with the bank card wherein the first account comprises a first balance maintained in real world currency. The method may further include adding a second account to the bank card wherein the second account is commonly owned with the first account and wherein the second account comprises a second balance maintained in a virtual medium.

A method of the present invention is provided for backing a virtual value with a continually indexed asset. In one embodiment, the method includes funding a house account by purchasing an asset in a sufficient quantity to cover purchases of the asset by one or more consumers, wherein the asset is purchased at a current spot purchase price, the spot purchase price updated on a continuing basis. The method may include receiving a virtual value in a virtual medium from a consumer in exchange for a portion of the asset from the house account, wherein the quantity of the asset exchanged for the virtual value is based on a current spot price of the asset and a virtual-to-real exchange rate for the virtual medium. In one embodiment, the method includes crediting the asset quantity to a current asset account balance associated with the consumer.

In one embodiment, the method includes redeeming at least a portion of the current asset account balance wherein the redeemed portion is credited to a second account wherein the second account maintains a virtual value. In another embodiment, redeeming further comprises accessing a published spot price for the asset, the current rate in US dollars or some other currency and accessing a published real-to-virtual exchange rate for the virtual medium

A system of the present invention is also presented to support a bank card backed by virtual value. The system may be embodied by a purchase card that associates a consumer with a purchase account, a network that communicates data between elements of the system, a client transaction server that requests payment of funds over the network, the request in response to a transaction by the consumer using the purchase card, and a server. In particular, the server in the system, in one embodiment, includes a house account module, an asset exchange module, a merchant request module, and a debit module.

The house account module maintains a house account, the house account comprising a virtual value in a virtual medium in one embodiment. The asset exchange module, in one embodiment receives funds from a consumer in exchange for a portion of the virtual value from the house account. A quantity of the virtual value exchanged for the funds may be based on an internal spot price of the virtual value at the time the funds are received. The quantity of the virtual value purchased by the consumer increases a balance in a purchase account of the consumer in one embodiment.

In certain embodiments, the merchant request module receives the request for payment from the client transaction server over the network. In one embodiment, the debit module debits the purchase account of the consumer by selling a quantity of the virtual value backing the purchase account balance to the house account. The quantity of the virtual value sold to the house account is based on the internal spot price of the virtual value at the time of the transaction and on an amount of the transaction between the consumer and a merchant in one embodiment.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the present invention will be readily understood, a description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for backing card-initiated electronic transactions with a continually indexed asset in accordance with the present invention;

FIG. 2 is a schematic block diagram illustrating one embodiment of an apparatus for backing card-initiated electronic transactions with a continually indexed asset in accordance with the present invention;

FIG. 3 is a schematic block diagram illustrating an alternate embodiment of an apparatus for backing card-initiated electronic transactions with a continually indexed asset in accordance with the present invention;

FIG. 4 is a schematic flow chart diagram illustrating one embodiment of a method for backing card-initiated electronic transactions with a continually indexed asset in accordance with the present invention;

FIG. 5 is a schematic flow chart diagram illustrating one embodiment of a method for backing card initiated electronic transaction with a virtual account in accordance with the present invention;

FIG. 6 is a schematic flow chart diagram illustrating one embodiment of a method for backing card-initiated electronic transactions with a continually indexed asset in accordance with the present invention; and

FIG. 7 is a graphical representation illustrating one embodiment of a method for determining a volatility index and fixed time period of a current spot price of an asset in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, a digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

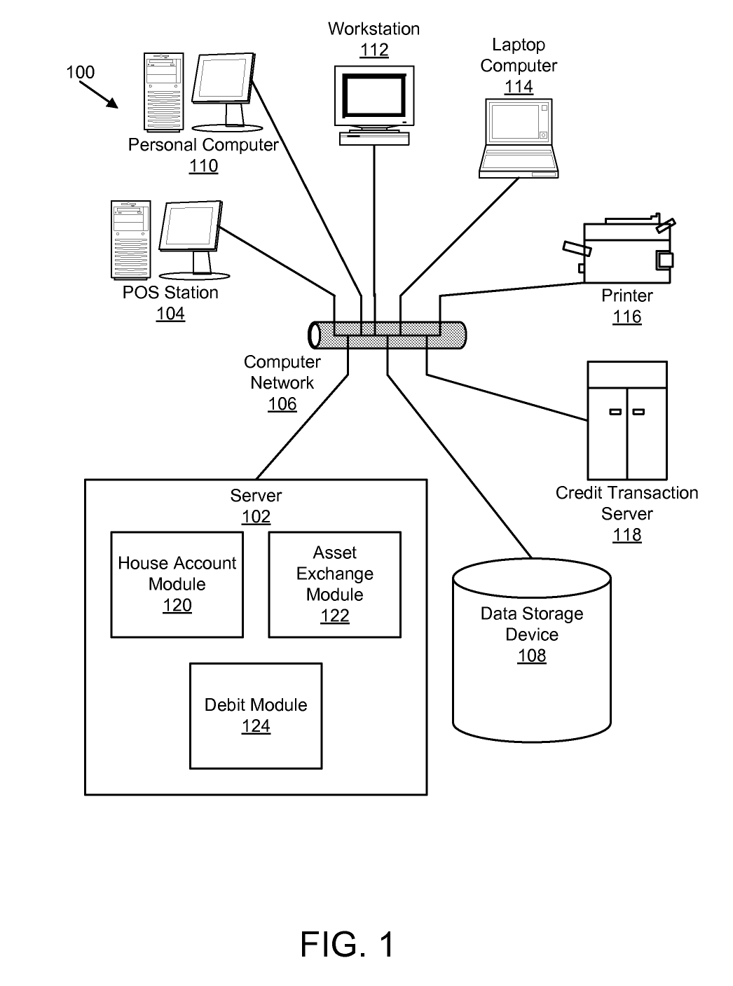

FIG. 1 depicts a system 100 for backing card-initiated electronic transactions with a continually indexed asset, a virtual value associated with a consumer account, or a combination of continually indexed asset and virtual value. Virtual values, virtual mediums, virtual worlds and other virtual terms are more fully defined herein. The system 100 includes a server 102 in communication with a point-of-sale (“POS”) station 104 through a computer network 106. The POS station 104 typically comprises a computer. However, the term “POS station” is intended to encompass other specialized electronic devices known in the art enabled to communicate with computer network 106. The server 102 may also be in communication with a data storage device 108. The system 100 may also include a personal computer 110, a workstation 112, a laptop computer 114, a printer 116, and other devices in communication with the server 102 through the computer network 106. The system 100 also includes a credit transaction server 118 in communication with the POS station 104 and the server 102.

The server 102 may be a personal computer, workstation, mainframe computer, or the like. The computer network 106 may comprise the Internet, a local area network, a wide area network, a storage area network, a wireless network, or the like. The computer network 106 may include a combination of the networks. The computer network 106 may include hubs, switches, routers, copper cabling, fiber-optic cabling, wireless devices, servers, and the like. One of skill in the art will recognize other elements of a computer network 106 for backing card-initiated electronic transactions with a continually indexed asset.

The POS station 104 may include a cash register, a personal computer, a terminal, a bar code scanner, a card reader, a keypad, a signature capture device, and the like. The POS station 104 is typically located at a merchant and may comprise a check stand with an array of POS equipment or may be a POS system, such as a mainframe computer or workstation hosting a website offering merchandise or services for purchase. The POS station 104 is typically capable of recording a transaction for merchandise or a service provided by a merchant and communicating the transaction through the computer network 106 to the credit transaction server 118 for credit approval and other transaction related communications. One of skill in the art will recognize other POS stations 104, networks, equipment, etc.

The data storage device 108 may be in communication with the server 102 and may store transaction information, asset information, account information, consumer profile information, and the like. The credit transaction server 118 may also be in communication with a data storage device 108 for similar purposes. The data storage device 108 may include hard disk drives, tape drives, optical drives, and the like. The data storage device 108 may be configured with a mirrored storage device, may include a redundant array of inexpensive disks (“RAID”), and may be part of a storage area network. One of skill in the art will recognize other data storage devices 108 and systems capable of storing transactions and other information related to backing card-initiated electronic transactions with a continually indexed asset, a virtual value, or a combination of a continually indexed asset and virtual value.

Typically, a consumer purchases a product or service from a merchant and the consumer or merchant swipes a credit or debit card, hereafter called bank card, of the consumer at a device connected to or part of the POS station 104. The POS station 104 may also be an automatic teller machine (“ATM”.) A merchant may also enter the bank card number through a keypad or keyboard of the POS station 104. A personal identification number (“PIN”) may be included with debit card information.

A consumer may also purchase a product or service using the telephone or Internet. In this environment, the physical bank card is not physically swiped, but rather the account number associated with the card is used to complete the transaction. Using the internet, the consumer may directly enter her bank card number into the workstation or computer being used to access the internet; or, alternatively, the card number may already be stored in the computer for convenience such that the consumer does not have to re-key in the bank card number each time additional purchases are made.

Also, some websites offering products or services may optionally save, at the consumer's request, his or her bank card number to more easily accommodate future purchases. A well known website offering this capability is amazon.com. In a telephonic purchase, a consumer typically communicates the bank card account number to the merchant by voice.

Through any of a variety of means, discussed herein, the bank card number and other relevant information, for example the PIN, are ultimately stored in the POS station 104. The POS station 104 typically transmits the information to a credit transaction server 118 for authorization and processing. The credit transaction server 118 then returns status to the POS station 104 and the consumer initiated transaction is completed. The POS station 104 may print a receipt. The POS station 104 may also transmit transaction information to the credit transaction server 118 for storage to a data storage device 108 or transmission to a third party, such as a bank, credit union, or financial institution that owns the bank card of the consumer (hereinafter “financial institution”).

The client transaction server 118 is typically owned and operated by a credit card processor that acts as a go-between for merchants and financial institutions. The credit card processor typically transmits transaction information through the credit transaction server 118 to the financial institution for payment. The financial institution transfers funds to the processor and the processor pays the merchant. The financial institution also typically debits an account of the consumer that made the purchase. In one embodiment, the processor typically deducts three to four percent of the amount of the transaction as a transaction fee and pays the merchant the remainder. In another embodiment, the processor pays the merchant the full transaction amount and bills the merchant for the transaction fee. The processor may also allow the financial institution to keep a portion of the transaction fee.

The server 102 of the present embodiment takes the place of the financial institution in that the credit transaction server 118 transmits merchant payment requests to the server 102 for payment. For typical bank cards, a transaction may be approved or rejected based on any number of factors pertaining to the consumer and account status. For example, one aspect typically relevant to an approval for a credit transaction pertains to the difference between the consumer's account balance and the consumer's credit limit. Approval generally occurs when the consumer's credit limit is greater than or equal to the purchase price of an item purchased with the consumer's credit card. For a debit transaction, a transaction is typically approved where the consumer's account balance is greater than the purchase price of the item being purchased. In another example, a transaction may not be authorized when the PIN code entered for a transaction fails to match the PIN code associated with the bank card account. For both credit and debit card transactions, the basis of the transaction is the currency of the country where the account exists. The cost of items purchased off-shore is converted to the currency of the country where the account exists based on some currency exchange rate in one embodiment.

A problem with currency-based transactions is that credit and debit accounts are subject to inflation of the basis currency that is not compensated for by a corresponding investment return paid to the accountholder; resulting in a loss of purchasing power for the accountholder. Once an item is purchased on a credit card, the consumer must pay a substantial interest rate because the credit card company must both make a profit and also hedge itself against inflation. For a debit account, the bank where the account exists only pays the accountholder a trivial amount of interest, if any interest is paid at all. In this case, the accountholder has tied up some amount of his/her capital in a non-interest-bearing checking account solely for the purpose of convenient spending (i.e., the consumer would prefer to keep the money in an account offering a higher return, such as a brokerage account, but does not, because it is inconvenient to spend money unless it is held in cash in a bank checking account due to high transaction costs, market closings, etc.).

The present invention overcomes many of the problems associated with currency-based bank cards by offering a bank card which can be used at the POS station just like a regular bank card, but is backed by a non-currency based asset, for example a virtual value, gold or silver, and/or backed by a virtual value associated with a consumer account. A bank card backed by a virtual value provides easy access to the virtual value in the real world. Gold, silver, or other precious metals serve as a hedge against inflation because they are traded on a world-wide market in units of ounces instead of currency units. Gold, silver, and other precious metals may appreciate in value over time at a rate higher than inflation. Some people invest money in gold and silver specifically because of these characteristics, but lose the ability to spend that money conveniently when they do so. Other assets may also back a bank card such as real estate, stocks, bonds, and the like. Almost all non-cash investment assets offer higher potential returns than bank checking accounts, but suffer from a lack of liquidity for instantaneous use in purchases, transfers, etc. The present invention brings the liquidity of non-cash investment assets to par with cash, while maintaining the unique investment profiles of those assets.

An additional problem with prior art bank cards is that they operate exclusively in the real world. The real world is defined as the physical environment in which inhabitants operatively and physically exist. However, virtual worlds, or multi-dimensional computer-simulated environments, are gaining in popularity at a rapid pace. These virtual worlds are intended for users to inhabit and interact via a defined representation of the user. An example of a virtual world is “secondlife.com,” an immersive virtual experience resembling our real world using 3D computer graphics and animation. In this virtual world, land may be purchased and sold, buildings erected, services rendered and paid for, and any imaginable real world activity accommodated.

Inhabitants of the real world have established generally-accepted real world values for elements in their physical environment for which exist units of measurement for communicating value. Like the real world, the participants in a virtual world may establish or adopt a virtual medium, a unit system of measurement wherein the unit has no formal value in an accredited real world banking institution. In one embodiment, a virtual medium might be a virtual currency system in which the virtual digital currency is a representation of money that does not have a real world counterpart.

The virtual world, secondlife.com, uses “Linden Dollars” as a virtual digital currency. Monopoly dollars, in a computerized game of monopoly, is another example of a virtual digital currency. Another embodiment of a virtual medium includes non-currency units such as points, reward points, bonus points, etc. that are accumulated and redeemed by a consumer in accordance with published rules directed to point accumulation and redemption. Non-currency units of a virtual medium are hereinafter referred to as virtual credits. Therefore, a virtual medium may comprise virtual digital currency or virtual credits. Accrual of a virtual digital currency or virtual credits by a user may be kept in a virtual account where balances are maintained in a virtual medium for a principal account owner.

Since there is a potential cross-over from a virtual world to the real world, such as presenting a virtual product for which a corresponding real product may exist, a virtual digital currency may take on a real world value. Furthermore, this valuation process may be formalized wherein, at any given point in time, a continuously updated and published virtual-to-real exchange rate may be utilized for the purpose of converting a virtual value into an equivalent real world currency value. A continuously updated and published real-to-virtual exchange rate may be utilized for the purpose of converting a real world currency value into an equivalent virtual value such as a virtual digital currency.

While real world value may be accruing in a consumer's virtual digital currency account, such as the Linden Dollar, it is very awkward to attempt to use that virtual world value in the real world. A typical process for gaining access to the real world value within a virtual digital currency account would involve requesting the redemption of virtual digital currency and then waiting for days for a real world check in an equivalent amount to be delivered. Furthermore, if the expenditure was actually less than anticipated, then some type of additional financial transaction would be necessary to place the remainder back into the virtual world, if that was the desire of the consumer.

Virtual credits, while having discernable value in the real world, are likewise awkward when it comes to extracting that real world value. Typically, virtual credits are highly restrictive as to the types of merchandise or services that may be obtained by a principal through virtual credit redemption. Therefore, a consumer may be forced to liquidate or trade a redeemed product or service in order to obtain a desired product or service. The present invention brings the liquidity of virtual digital currency and virtual credits to par with cash, while maintaining the unique characteristics of those virtual mediums in a virtual world or system.

Another problem in the virtual world addressed by the present invention pertains to a greater potential for experiencing loss or weak investment performance of real world value over time for virtual digital currency or virtual credits held in a virtual account. In one embodiment of the invention, a virtual value, which is the quantity of units held in a virtual medium, associated with a current account balance in a virtual account, may in whole or in part be used to fund the backing in gold or other real world assets as discussed herein.

The server 102 may include, in one embodiment, a house account module 120, an asset exchange module 122, and a debit module 124, all of which will be explained in detail below. The house account module 120 is configured to fund a house account by purchasing an asset in a sufficient quantity to cover consumer purchases of the asset. The asset has a substantially continually updated spot purchase price. A spot price of a commodity, a security or a currency is the exchange rate that is quoted for immediate settlement. The house account module 120 purchases the asset at the spot purchase price. The asset purchased through the house account module 120 may be a virtual value, gold, silver, platinum, palladium, or another valuable asset. In one embodiment, the asset includes shares of a real estate investment trust (“REIT”). In another embodiment, the asset comprises stocks, bonds, or a combination of both. The stocks and bonds may be a mix of funds comprising an index fund that follows an index, such as the Standard and Poor 500 or the Dow Jones Industrial Average. The stocks and bonds may also be in any mutual fund of the type offered for sale by many investment firms.

It is through the use of the house account module 120 that the liquidity offered by the present invention is made possible. Without a house account module 120, each buy or sell of the backing asset would require a transaction on the open (public) market, which would be prohibitively expensive for the cardholder. By pooling all cardholders' assets into a house account, and transacting within the house account to the maximum extent possible, it is practical and possible to offer an asset-backed spending account that does not suffer from the high cost and low liquidity of a traditional investment account.

In a preferred embodiment, the asset has a spot price that is continuously available or nearly continuously available. For example, a spot price for gold or silver is typically continuously available because gold is traded world wide and usually a market somewhere in the world is always open. In another embodiment, a current spot price is variable in a particular market during trading hours and remains fixed at a market closing price. In yet another embodiment, a current spot price is variable for most of the time but may be fixed for short periods of time, such as after one market closes and before another opens. One of skill in the art will recognize other ways that an asset may have a substantially continuously updated current spot price.

Typically, the house account module 120 purchases a quantity of the asset when an amount of uncommitted assets in the house account falls below a specified level. The house account module 120 may also sell a portion of the asset where the amount of uncommitted assets increases above a specified level. The house account module 120 may purchase or sell quantities of the asset automatically or in response to input from an account manager. The house account module 120 may also send an alert when the quantity of uncommitted assets increases or decreases beyond an alert limit.

The server 102 may also include an asset exchange module 122 that receives funds from the consumer in exchange for a portion of the asset from the house account. The quantity of the asset exchanged for the funds is based on a current spot price of the asset at the time the funds are received. Determination of the current spot price is discussed below. In one embodiment, the current spot price used to exchange the asset for the consumer's funds is increased by a purchase fee. A purchase account is typically configured to allow a particular consumer to make purchases where the purchase price is debited to the consumer's purchase account. The purchase account may include a unique account number, a user name, a PIN, etc. The purchase account may be an account accessible by the consumer through a financial institution, through the Internet, etc. The purchase account is typically associated with consumer information, such as the consumer's name, address, phone numbers, email addresses, and the like, with the purchase account. One of skill in the art will recognize other attributes of a purchase account of a consumer.

In another embodiment, the consumer's purchase account is a virtual account that is an account where the balance is maintained in a virtual medium. As discussed above, a virtual medium may be virtual digital currency or may be virtual credits. A value maintained in a virtual medium, hereinafter referred to as a virtual value, may have a determinable value in the real world by applying a virtual-to-real exchange rate associated with the virtual medium. The real result of applying a current virtual-to-real exchange rate yields an equivalent real world value in a currency recognizable in the real world. An equivalent real value may be utilized to purchase assets from the house account; in this case the corresponding equivalent virtual value associated with the equivalent real value is debited from the consumer's purchase virtual account. In still another embodiment, the equivalent real world value corresponding to a virtual value is debited from the virtual account and credited to a real world account and then the real world account is used to acquire indexed assets as described herein.

In one example, the current spot price may be increased by a percentage. In one embodiment, the current spot price is increased by 2%. In another embodiment, the current spot price for consumer purchases of the asset is increased by a fixed amount. For example, the fixed amount may be set in a table where the fee varies such that there is a different fee for different ranges of purchase amounts. In another embodiment, the purchase fee is a combination of a fixed amount and a percentage. One of skill in the art will recognize other ways to increase a current spot price with a purchase fee.

Once the asset exchange module 122 exchanges a quantity of the asset for the funds provided by the consumer, the asset exchange module 122 applies the asset to an asset account of the consumer. For example, if the consumer provides $10,000 to purchase a quantity of the asset and the asset is gold, the current spot price for gold is determined at the time the consumer tenders $10,000. If the current spot price is determined to be $580/ounce (ounce may be abbreviated “oz”) for gold and the purchase fee is 2% of the current spot price, the current spot price will be $580+($580×0.02)=$591.60. The exchange will be $10,000/$591.60/oz=16.903313 oz. The asset exchange module 122 places a value of 16.9 oz of gold in the consumer's asset account. In another example, the consumer uses a virtual account and requests to purchase 100,000 units worth of the asset in virtual digital currency (such as Linden dollars). Assuming a virtual-to-real exchange rate of 10:1 for US dollars, a debit of 100,000 units is made from the consumer's virtual account and an equivalent real value of $10,000 is used to acquire the indexed gold asset. At this point, assuming the same parameters from the first example, the same 16.9 ounces of gold is placed into the consumer's asset account.

The server 102 includes, in one embodiment, a debit module 124 that debits the asset account of the consumer by selling a quantity of the asset backing the asset account balance to the house account. The quantity of the asset sold to the house account is based on the current spot price of the asset at the time of the transaction and on an amount of a transaction between the consumer and a merchant. The transaction is typically based on a bank card purchase by the consumer wherein the bank card is backed by the balance in the asset account.

Typically, the asset is sold to the house account at a current spot price at the time of the transaction. The consumer typically initiates the transaction by purchasing a product or service from a merchant using a bank card that is backed by the consumer's purchase account. The bank card may be a credit card, debit card, or both. The bank card may also be an ATM card. The bank card is typically part of the Visa® or MasterCard® network or a similar network such as the Discover Card or American Express® card network. The POS station 104 of the merchant typically gathers all pertinent information and validates the transaction through a processor via the credit transaction server 118. The credit transaction server 118 communicates the transaction amount and other details, such as consumer identification information, to the debit module 124 of the server 102. The debit module 124 debits the consumer's asset account based on the amount of the transaction and a current spot price of the asset backing the consumer's purchase account.

In an alternative embodiment, the debit module 124 debits a consumer's virtual account in place of debiting the consumer's asset account. Indeed, in this embodiment, the asset account for the consumer may or may not exist. The amount of the debit is determined by utilizing a real-to-virtual exchange rate associated with the virtual medium that is utilized by the virtual account to convert the transaction amount to an equivalent virtual value. Then, the equivalent virtual value is debited from the current virtual account balance to generate a new current virtual account balance representing the virtual value that will remain following the completion of the transaction.

Prior to validating the transaction, typically the processor verifies that the consumer has adequate assets in the consumer's asset account to cover the transaction amount. Alternatively, in the case of backing by a consumer's virtual account, the virtual value in the virtual account is checked for adequacy with respect to the transaction amount. In an alternate embodiment, the merchant deals directly with the server 102 to verify the consumer's account can cover the transaction amount. In one embodiment, a processor is not involved and the server 102 performs the tasks typically done by the processor and credit transaction server 118.

In one embodiment, if a backing asset account or backing virtual account has a balance that is insufficient to cover the transaction amount, the transaction fails. In another embodiment, a check is made to determine if a consumer backing account associated with the bank card is linked to another account. If so, a secondary account linked to the primary account associated with the bank card may be accessed to determine if adequate funds are available in the secondary account or if adequate funds are available in a combination of the primary account and secondary account. If adequate funds are available in one, the other, or combination of accounts, the transaction may proceed. One of ordinary skill in the art will readily recognize that various implementation rules may govern the specifics of how many and which accounts, and in what combination they may be utilized, and under what conditions various rules may apply.

In one embodiment a bank card is static with respect to the account or accounts associated with the card. Alternatively, the accounts associated with a given bank card may be dynamic. Dynamic bank cards allow a consumer to request that the primary account already existing and associated with the bank card be linked to an additional account. The additional account may be of the same type as the primary account or it may be a different type. For example, a primary account may be a conventional real world currency account that a consumer requests to link to a new asset backed account or a new virtual account. While the issuer of a bank card may have various restrictions on account linking, the present invention anticipates dynamic linking for any combination of accounts.

In another embodiment a single account may have a plurality of balances reflecting a plurality of virtual mediums. In another embodiment still, a bank card may be linked to a plurality of accounts comprising homogenous account types (such as all virtual accounts) or, alternatively, comprising a non-homogenous mix of account types spanning asset based accounts, real world financial accounts and virtual accounts in any combination.

In one example, if the consumer purchases a product from a merchant for $20 and the consumer's asset account has an adequate balance to cover the purchase, the debit module 124 determines a quantity of the asset to be deducted from the consumer's asset account. If the asset is gold and the current spot price for gold was $600/oz at the time of the transaction, the debit module determines how many ounces of gold to deduct from the asset account: $20÷$600/oz.=0.033333 oz. If the asset account balance is 16.093313 oz then the balance becomes 16.0903313−0.033333=16.0569983 oz. The house account is increased by 0.03333 oz of gold.

In another example, the debit module 124 is directed to a consumer's virtual account. The debit module 124 determines a virtual value, such as Linden Dollars or the like, to be deducted from the consumer's virtual account. If the real-to-virtual exchange rate is 10:1, then the $20 purchase amount above converts to $200 Linden dollars, which is then deducted from the consumer's virtual account. As discussed above, exchange rates associated with virtual accounts, either virtual-to-real exchange rates or real-to-virtual exchange rates, are published for a virtual medium in order for a virtual account using that medium to qualify as a backing account. One of ordinary skill in the art will recognize that the publication of exchange rates will occur more or less frequently for any given virtual medium having such publication. Ideally, the rates are continuously updated at least every few minutes. However, the scope of the present invention anticipates any rate of publication from a fraction of a second to yearly with a greater degree of fairness to all participants in the system occurring as the frequency increases.

In one embodiment, the debit module 124 uses the current spot price at the time of the transaction. In another embodiment, the debit module 124 uses a current spot price at a time later than the transaction, such as the time the server 102 receives a request to debit the consumer's purchase account. One of skill in the art will recognize other times that a current spot price can be determined in relation to a consumer's transaction.

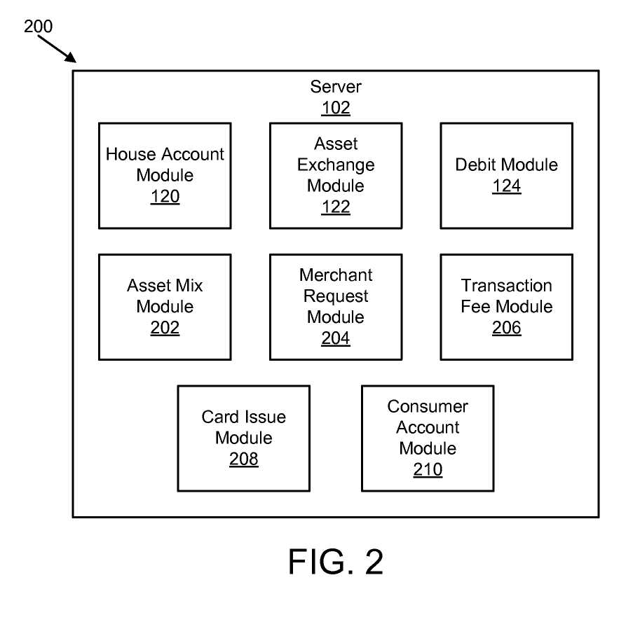

FIG. 2 is a schematic block diagram illustrating one embodiment of an apparatus 200 for backing card-initiated electronic transactions with a continually indexed asset in accordance with the present invention. In one embodiment, the apparatus 200 includes a house account module 120, an asset exchange module 122, and a debit module 124, substantially similar to the same module described in relation to FIG. 1. In addition, the server 102 may include an asset mix module 202, a merchant request module 204, a transaction fee module 206, a card issue module 208, and a consumer account module 210, which are described below.

The server 102 may include an asset mix module 202 that creates a mix of assets in a consumer's asset account. The house account module 120, in one embodiment, acquires more than one asset for multiple house accounts. For example, one house account may be based on acquisition of gold. Another house account may be backed by silver, another by platinum, another by palladium, another by a REIT, another by stocks, another by virtual accounts, etc. The asset mix module 202 may allow a consumer to designate an asset mix in the consumer's asset account.

For example, a consumer may designate 50% gold, 25% silver, and 25% platinum. Funds provided by the consumer may be split so that 50% purchase gold for the purchase account, 25% of the funds purchase silver, and 25% of the funds purchase platinum. In one embodiment, the consumer designates an asset mix during a set-up of the purchase account and any funds added after that time are split based on the designated asset mix. In another embodiment, the consumer designates an asset mix each time the consumer provides funds for the consumer's asset account. In another embodiment, funds are split based on an asset mix agreement, but the consumer can override the agreement each time funds are provided for the asset account.

In one embodiment, the consumer may reallocate the asset mix of the consumer's asset account. In another embodiment, the consumer is restricted from changing the asset mix of previously purchased assets. In another embodiment, the consumer may reallocate assets via the Internet. In another embodiment, the consumer may designate which assets are to be used for a particular merchant transaction. In another embodiment, assets are used to pay for a transaction in amounts equal to the consumer's asset mix agreement. One of skill in the art will recognize other ways the asset mix module 202 may control an asset mix of a consumer when funds are provided by the consumer, for reallocation of assets, and for transactions.

In one embodiment, the server 102 includes a merchant request module 204 that receives a request for funds from a merchant based on the transaction between the merchant and consumer. The merchant request module 204 also pays the merchant currency based on the amount of the transaction. The merchant request module 204 typically receives requests for payment from the credit transaction server 118 after a consumer has made a purchase from the merchant using the consumer's card backed by the consumer's asset account. The merchant request module 204 typically then receives a request for funds from the merchant through the credit transaction server 118. The merchant request module 204 typically pays the merchant for the amount of the transaction through the credit transaction server 118.

The server 102 in another embodiment, includes a transaction fee module 206 that retains a portion of the amount of the transaction, wherein the portioned retained represents a portion of a transaction fee. The amount retained is typically agreed upon with the processor. In one embodiment the transaction fee module 206 retains a portion of the transaction amount when the transaction amount is paid to the merchant involved in the transaction. In another embodiment, the transaction fee module 206 receives a portion of the transaction fee in a regular payment from the processor. One of skill in the art will recognize other ways that the transaction fee module 206 may receive a portion of the transaction fee.

Where the card used by the consumer is a debit card or a combination credit/debit card and the consumer uses a debit transaction, the transaction fee module 206 may charge a transaction fee to the consumer instead of the merchant. In another embodiment, the transaction fee module 206 does not charge a fee for a debit transaction. Determination of whether to charge a debit fee may be based on marketing decisions.

The server 102 may include a card issue module 208 that issues a bank card to a consumer backed by the consumer's asset account. The card issue module 208 may issue a credit card, a debit card, or a combination of the two. The card issue module 208 may issue a bank card after the asset exchange module 122 receives funds from the consumer. In another embodiment, a credit card vendor, such as Visa or MasterCard, issues a bank card to the consumer and the card issue module 208 establishes a link between the bank card and the consumer's asset account. In an alternative embodiment, the issue module 208 establishes a link between the bank card and the consumer's virtual account. In yet another embodiment, the issue module 208 establishes a link between a new account of any type and a previously bank card-linked account of any type.

The server 102 may include a consumer account module 210 that establishes an asset account and/or a virtual account for a consumer. The consumer account module 210 may receive consumer identification information, credit worthiness information, an assigned account number, or other information pertinent to establishment of the consumer's account. The consumer account module 210 may link the consumer's account to a network accessible by a processor or merchants. The consumer account asset module 210 may also activate the asset or virtual account after receiving confirmation from the asset exchange module 122 indicating a positive balance in the account.

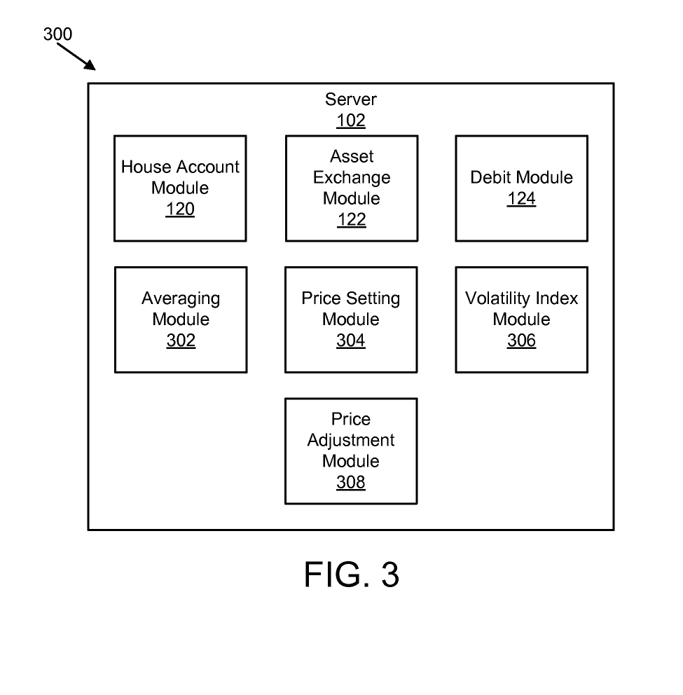

FIG. 3 is a schematic block diagram illustrating an alternate embodiment of an apparatus 300 for backing card-initiated electronic transactions with a continually indexed asset in accordance with the present invention. The apparatus 300 may include, in one embodiment, a house account module 120, an asset exchange module 122, and a debit module 124, substantially similar to the same module described in relation to FIG. 1. The apparatus 300 may also include an averaging module 302, a price setting module 304, a volatility index module 306, and a price adjustment module 308, which are described below.

The server 102, in one embodiment, includes an averaging module 302 that averages at least two spot prices. The spot prices are substantially continually available. Typically, the averaging module 302 averages two spot prices. For example, if one spot price for gold is $580/oz and another is $600/oz, the averaging module 302 averages the two prices to get $590/oz. In one embodiment, the averaging module 302 uses a single spot price. In another embodiment, the averaging module 302 averages three or more spot prices for an asset. In still another embodiment the averaging module 302 averages a plurality of virtual-to-real exchange rates or a plurality of real-to-virtual exchange rates.

In one embodiment, the averaging module 302 verifies that the spot prices used for averaging are not in error. For example, if one price is $580/oz and another is $6/oz, the averaging module 302 may determine that the $6/oz price is too low and may select another price to average or may use the $580/oz price. The averaging module 302 may determine that the spot prices are correct by comparing the prices to a previous current spot price. In another embodiment, the averaging module 302 creates a ratio of the difference between spot prices to the spot price and determines that the spot price is in error if the ratio is too high. The averaging module 302 may use any mathematical function or other algorithm to verify that one or more of the spot prices are not in error prior to averaging the spot prices.

The server 102 may also include a price setting module 304 that sets a current spot price for a fixed time period. The price setting module 304 sets the current spot price typically to be the average of the at least two spot prices from the averaging module 302. A consumer may purchase or sell a quantity of the asset at the current spot price during the fixed time period or a real world digital currency may be converted to a virtual value in the same fixed time period with a spot real-to-virtual exchange rate. Similarly, the conversion in the fixed time period may be from a real world digital currency to a virtual value using a spot virtual-to-real exchange rate. Typically the fixed time period is set to approximately 15 minutes, but may be set longer or shorter. The fixed time period is usually set to a value that minimizes computer resources while maintaining a price that is reasonably accurate in comparison with the spot price. The minimum fixed time period may be set to the minimum time period for changing the spot prices. One of skill in the art will recognize other ways to fix a time period for the current spot price.

The server 102 also includes a volatility index module 306 that determines a volatility index of the current spot price by analyzing a trend based on the current spot price and at least one previous current spot price. The volatility index module 306, in one embodiment, uses a percentage change algorithm to determine the volatility index. In another embodiment, the volatility index module 306 uses a curve fitting algorithm to determine the volatility index. For example, if the volatility index module 306 determines that the percent change from a present value of the current spot price to a previous value of the current spot price is above a limit, the volatility index module 306 sets a particular value for the volatility index. For example, if the volatility index module 306 determines that the present value of the current spot price is 2%, the volatility index module 306 may set the volatility index to a value of 2.

In another embodiment, the volatility index module 306 uses the slope of a curve determined by a curve fitting algorithm to determine the volatility index. For example, the volatility index module 306 may use one or more past values of the current spot price to determine a slope. If the slope is 2, the volatility index may be set to 2. Typically, the greater percent change in the current spot price or the greater the slope, the greater the volatility index. If an inverse relationship is used for the volatility index, the greater percent change in the current spot price or the greater the slope, the lesser the volatility index.

In one embodiment, the volatility index module 306 samples spot prices at a time period less than the fixed time period used by the current spot price. The volatility index module 306 may establish a curve through a curve fitting algorithm and find the slope of the curve by taking a derivative of the curve or some other more simple means. One of skill in the art will recognize other ways that the volatility index module 306 may determine a volatility index based on changes in a current spot price.

The server 102 may include a price adjustment module 308 that adjusts the fixed time period based on the volatility index of the current spot price. For example, if the volatility index is 2 based on a slope or percentage increase of the current spot price, the price adjustment module 308 may decrease the fixed time period associated with the current spot price. For example, if the fixed time period is 15 minutes and the volatility index is 2, the price adjustment module 308 may adjust the fixed time period to 15/2=7.5 minutes. If a reciprocal relationship is used for the volatility index and the volatility index is 0.5, the price adjustment module 308 may adjust the fixed time period to 15×0.5=7.5 minutes. The price adjustment module 308 may use a lookup table, a mathematical function, or the like to adjust the fixed time period based on the volatility index. One of skill in the art will recognize other ways that the price adjustment module 308 may adjust the fixed time period based on the volatility index.

In another embodiment, the price adjustment module 308 adjusts the current spot price based on the volatility index. For example, the price adjustment module 308 may increase the current spot price by 10% when the volatility index indicates that the current spot price is rising. In another example, the price adjustment module 308 may decrease the current spot price by 20% for a decrease in the volatility index. In yet another embodiment, the price adjustment module 308 adjusts both the fixed time period and the current spot price.

In an alternate embodiment, the server 102 uses past and present available spot prices to determine a volatility index, adjusts the spot prices and then the averaging module 302 averages the adjusted spot prices. In summary, the server 102 may use any method to determine a current spot price for use with asset purchase/sale or conversion of virtual values to equivalent real values that reflects a reasonably accurate spot price for the asset or conversion from or to virtual value.

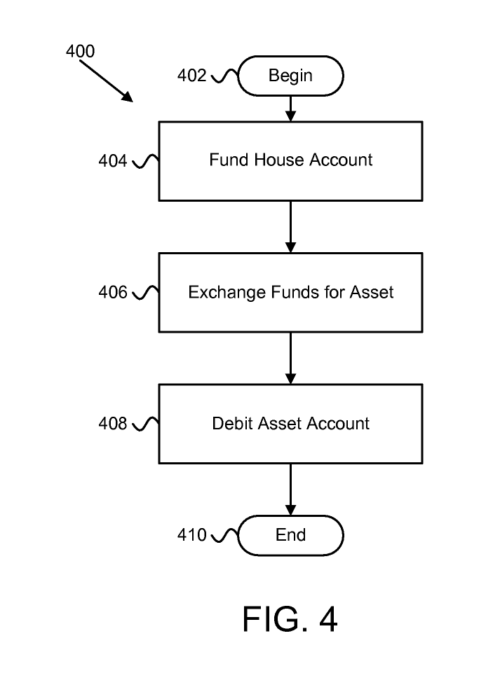

FIG. 4 is a schematic flow chart diagram illustrating one embodiment of a method 400 for backing card-initiated electronic transactions with a continually indexed asset in accordance with the present invention. The method 400 begins 402 and the house account module 120 funds 404 a house account by purchasing an asset in a sufficient quantity to cover consumer purchases of the asset. The asset may be gold, silver, platinum, a REIT, virtual currency, or the like. The asset has a substantially continually updated spot purchase price and the asset is purchased at the spot purchase price.

The asset exchange module 122 receives 406 funds from the consumer in exchange for a portion of the asset from the house account. The funds received by the asset exchange module 122 may be from one or more of a variety of sources. One source is a consumer's real world financial account. Another source is from a consumer's virtual account. Another still is from a financial transaction initiated from a bank card. Another source still is a check mailed to an administrator and manually entered into a computer utilizing a keyboard. Other forms of payment of funds are well known in the art and are anticipated by the present invention. The quantity of the asset exchanged for the funds is based on a current spot price of the asset at the time the funds are received. The value of the asset purchased by the consumer increases a balance in an asset account of the consumer. The consumer account module 210 creates the asset account for the consumer and relates the asset account to assets purchased by the consumer.

The debit module 124 debits 408 the asset account of the consumer by selling a quantity of the asset backing the asset account balance to the house account and the method 400 ends 410. The quantity of the asset sold to the house account is based on a current spot price of the asset at the time of the transaction and on an amount of a transaction between the consumer and a merchant. The transaction is based on a credit/debit card purchase by the consumer. The credit card is backed by the balance in the asset account. The credit/debit card may be issued by the card issue module 208.

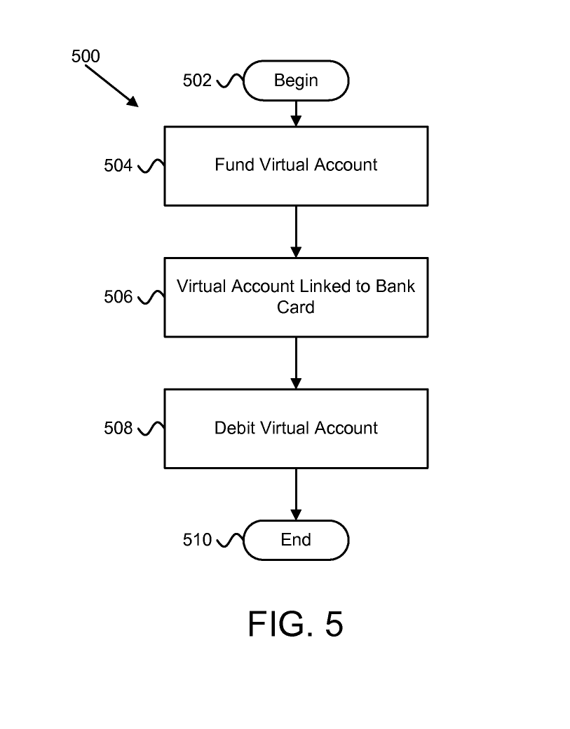

FIG. 5 is a schematic flow chart diagram illustrating one embodiment of a method 500 for backing a bank card with a virtual account. The method 500 begins 502 and the asset exchange module 122 receives funds 504 to be credited to a consumer's virtual account. As discussed herein, the consumer funds may be received 504 from a variety of sources. The asset exchange module 122 utilizes the real-to-virtual exchange rate, corresponding to the virtual medium associated with the virtual account into which the funds are to be credited, to convert the incoming fund amount in real world currency into an equivalent virtual value. The equivalent value is then credited to the virtual account. In another embodiment a virtual account is funded with virtual currency or virtual credits acquired in a virtual world.

The consumer account module 210 links 506 the virtual account to a consumer bank card. In one embodiment, the card issue module 208 issues the bank card prior to the consumer account module 210 linking the virtual account to the bank card.

The debit module 124 debits 508 the virtual account balance by an equivalent virtual value corresponding to a real world transaction amount generated by a purchase utilizing a bank card backed by the virtual account. The debit module 124 calculates the equivalent virtual value by utilizing a published real-to-virtual exchange rate, corresponding to the virtual medium associated with the consumers virtual account linked to the consumer's bank card. The method 500 ends 510.

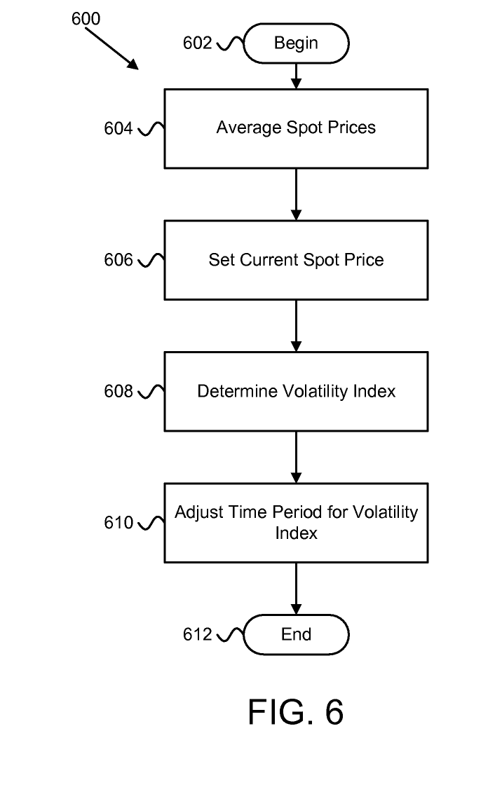

FIG. 6 is a schematic flow chart diagram illustrating one embodiment of a method 600 for backing card-initiated electronic transactions with a continually indexed asset in accordance with the present invention. The method 600 begins 602 and the averaging module 302 averages 604 at least two spot prices of an asset. The spot prices are substantially continually available. For example, two spot prices of gold may be averaged.

The price setting module 304 sets 606 a current spot price for a fixed time period. The current spot price typically is the average of the at least two spot prices. A consumer may purchase or sell a quantity of the asset at the current spot price during the fixed time period. The volatility index module 306 determines 608 a volatility index of the current spot price by analyzing a trend based on the current spot price and at least one previous current spot price. In an alternate embodiment the volatility index module 306 determines 608 a volatility index by examining trends in spot prices sampled at a rate more frequent than the fixed time period.

The price adjustment module 308 adjusts 610 the fixed time period based on the volatility index of the current spot price and the method 600 ends 612. In an alternate embodiment the price adjustment module 308 adjusts 610 the current spot price based on the volatility index.

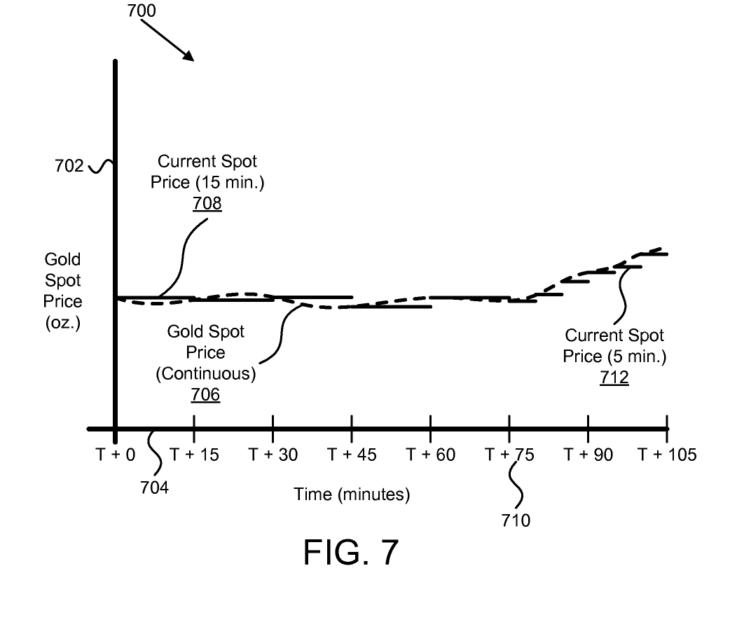

FIG. 7 is a graphical representation 700 illustrating one embodiment of a method 600 for determining a volatility index and fixed time period of a current spot price of an asset in accordance with the present invention. A hypothetical graph 700 of a gold spot price is depicted. The graph 700 includes gold spot prices on the vertical axis 702 and time on the horizontal axis 704. A hypothetical gold spot price curve 706 (dashed lines) is depicted that varies in price over time. The fixed time period is chosen to be 15 minutes, so the time axis displays units of 15 minute increments. At the beginning of the graph 700, the gold spot price curve 706 is relatively flat so every 15 minutes the current spot price 708 (line segments of 15 minutes) is adjusted.

At around T+75 minutes 710, the gold spot price curve 708 starts to change at a more rapid rate. The volatility index module 306 determines that the current spot price is more volatile and increases the volatility index. The price adjustment module 308 then reduces the fixed time period of the current spot price 712 (line segments of 5 minutes) to maintain accuracy of the current spot price within tolerable limits. In another embodiment, (not shown) the price adjustment module adjusts the current spot price or adjusts the current spot price and the fixed time period. For example, the current spot price may be adjusted upward when the volatility index indicated that the current spot price is increasing. In addition, the price adjustment module 308 may also decrease the fixed time period.

Beneficially, the present invention provides a bank card backed by an asset such as gold or silver rather than a credit account or bank account on a currency basis. Alternatively, and also beneficially, the present invention provides a bank card backed by a virtual account, such as an account utilizing a virtual digital currency as the virtual medium or an account utilizing a virtual credit as the virtual medium. Furthermore, a virtual account may be beneficially utilized as funds in generating or augmenting an asset account. The present invention allows a consumer to purchase a quantity of the asset and then allows the asset to grow as a hedge against inflation. The present invention offers flexibility of a credit/debit card for accessing the assets or the real world value in a virtual account, which are features not provided by other investment schemes, such as 401k accounts or brokerage accounts.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code executable to perform operations for performing a financial transaction initiated at a point-of-sale station, the method comprising:
receiving point-of-sale information from a consumer comprising a real currency purchase amount and account information, the account information determined from a bank card;
converting the real currency purchase amount to an equivalent virtual value utilizing a current real-to-virtual exchange rate associated with a virtual medium; and
processing the transaction, the processing comprising debiting a current virtual value balance by the equivalent virtual value, the current virtual value balance associated with an account naming at least the consumer, the account determinable from the account information.

2. The computer program product of claim 1 wherein the point-of-sale station is an automated teller machine (ATM).

3. The computer program product of claim 1 wherein the point-of-sale station is a website.

4. The computer program product of claim 1 wherein the point-of-sale station comprises a retail card reader.

5. The computer program product of claim 1 wherein the bank card is a debit card.

6. The computer program product of claim 1 wherein the bank card is a credit card.

7. The computer program product of claim 1 further comprising denying the transaction if the current virtual value balance is insufficient to proceed with the debit.

8. The computer program product of claim 1 wherein the virtual medium is a virtual digital currency.

9. The computer program product of claim 1 wherein the virtual medium is a virtual credit.

10. The computer program product of claim 9 wherein the virtual credit comprises points that are earned in the account based upon the activities of the consumer.

11. The computer program product of claim 1 wherein the current virtual value balance is incremented based upon the consumer depositing real world currency into the account.

12. The computer program product of claim 1 wherein the current real-to-virtual exchange rate is published by a website, wherein the website offers services based on the virtual medium.

13. The computer program product of claim 1 wherein the current virtual value balance to be debited is a plurality of current virtual value balances.

14. The computer program product of claim 13 wherein the account is a plurality of accounts.

15. A method for performing a financial transaction initiated at a point-of-sale station, the method comprising:
receiving point-of-sale information comprising a real currency purchase amount and account information, the account information determined from a bank card;
determining that a virtual value balance in a first account associated with the account information is insufficient to complete the transaction;
accessing a second account associated with the account information wherein the second account comprises a second balance or credit limit in a real world currency; and
processing the transaction, the processing comprising debiting at least a portion of the real currency purchase amount from the second balance.

16. The method of claim 15 further comprising:
determining a first account associated with the bank card wherein the first account comprises a first balance maintained in real world currency;
adding a second account to the bank card wherein the second account is commonly owned with the first account and wherein the second account comprises a second balance maintained in a virtual medium.

17. A method for backing a virtual value with a continually indexed asset, the method comprising:
funding a house account by purchasing an asset in a sufficient quantity to cover purchases of the asset by one or more consumers, wherein the asset is purchased at a current spot purchase price, the spot purchase price updated on a continuing basis;
receiving a virtual value in a virtual medium from a consumer in exchange for a portion of the asset from the house account, wherein the quantity of the asset exchanged for the virtual value is based on a current spot price of the asset and a virtual-to-real exchange rate for the virtual medium; and
crediting the asset quantity to a current asset account balance associated with the consumer.

18. The method of claim 17 further comprising redeeming at least a portion of the current asset account balance wherein the redeemed portion is credited to a second account wherein the second account maintains a virtual value.

19. The method of claim 18 wherein the redeeming further comprises accessing a published spot price for the asset and accessing a published real-to-virtual exchange rate for the virtual medium.

20. A system for supporting a bank card backed by virtual value comprising:
a purchase card that associates a consumer with a purchase account;
a network that communicates data between elements of the system;
a client transaction server that requests payment of funds over the network, the request in response to a transaction by the consumer using the purchase card; and
a server comprising:
a house account module maintaining a house account, the house account comprising a virtual value in a virtual medium;
an asset exchange module receiving funds from a consumer in exchange for a portion of the virtual value from the house account, wherein a quantity of the virtual value exchanged for the funds is based on an internal spot price of the virtual value at the time the funds are received and wherein the quantity of the virtual value purchased by the consumer increases a balance in a purchase account of the consumer;
a merchant request module receiving the request for payment from the client transaction server over the network; and
a debit module debiting the purchase account of the consumer by selling a quantity of the virtual value backing the purchase account balance to the house account, wherein the quantity of the virtual value sold to the house account is based on the internal spot price of the virtual value at the time of the transaction and on an amount of the transaction between the consumer and a merchant.
